(19) United States
(12) Patent Application Publication
(10) Pub. No.: US 2010/0021737 A1
(43) Pub. Date: Jan. 28, 2010

(54) METHOD OF FILM-COATING ARTICLES

(75) Inventors: Erich Beck, Ladenburg (DE); Lars Koppelmann, Mannheim (DE); Roland Streng, Fraenkisch-Crumbach (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/445,079

(22) PCT Filed: Oct. 11, 2007
(86) PCT No.: PCT/EP2007/060831

§ 371 Date: Apr. 10, 2009

(30) Foreign Application Priority Data
Oct. 13, 2006 (EP) 06122227.9

(51) Int. Cl. B32B 9/04; B29C 35/08; C08F 2/50

(52) U.S. Cl. 428/411.1; 264/496; 522/64

(57) ABSTRACT

The present invention relates to a simplified method of film-coating articles by means of radiation curing.

The present invention relates to a simplified method of film-coating articles by means of radiation curing.

EP 819 520 A2 describes the production of insert-molded thermoformed dry-paint films whose paint is cured by means of radiation curing.

The disclosure embraces only the radiation curing after the insert molding has taken place; in other words, radiation curing in one step, taking place separately from the insert molding and thermoforming.

WO 06/000349 describes an apparatus for radiation curing, if appropriate under an inert atmosphere.

A disadvantage of the apparatus presented therein is that it does not provide any thermoforming facility.

WO 00/63015 (U.S. Pat. No. 6,777,089 B) discloses a method in which radiation-curable films are produced. There, however, the radiation curing takes place preferably after the thermoforming and with particular preference after the insert molding.

DaimlerChrysler HighTechReport January 2005 (http://www.daimlerchrysler.com/Projects/c2c/channel/documents/682160_hightechreport_{—}01_{—}2005_filmcoating_g.pdf) describes a coating station in which a radiation-curable film is produced in a plurality of separate production steps. A decisive feature of the operation produced therein is that drying and curing are separate. Again, thermoforming and UV curing are carried out in two separate worksteps.

Consequently, two separate apparatuses must be provided, which increases the expense and complexity of the method and necessitates devices and floor space.

It was an object of the present invention to provide a simplified curing method with which, accompanied by a reduced level of device cost and complexity, it is possible to carry out shaping and curing of radiation-curable films.

This object has been achieved by means of a method of producing a film-coated article, comprising at least the following steps:
1) production of a composite film by coating of a film-form substrate D), which if appropriate may comprise further, optional interlayers B) and/or C), with at least one radiation-curable outer layer A),
2) if appropriate, drying of the composite film thus obtainable,
3) shaping of the composite film obtainable from 1) or 2) by thermoforming or attachment to an article,
4) radiation curing in 3) of the shaped composite film, and
5) if appropriate, insert molding of the shaped composite film cured in 4),
   wherein steps 3) and 4) are carried out in the same apparatus.

As a result of the uniting of the shaping step 3) and radiation-curing step 4) in one apparatus, the method of the invention can be carried out with simplified apparatus in comparison to the prior art, and requires less energy.

In one preferred embodiment, additionally, the drying step 2) can be carried out at least partly in the same apparatus.

In one preferred embodiment, additionally, step 5) can be carried out at least partly in the same apparatus.

The individual steps are set out in more detail below:
1) Production of a Composite Film By Coating of a Film-Form Substrate D), Which if Appropriate May Have Been Coated with Further, Optional Interlayers B) and/or C), With at Least One Radiation-Curable Outer Layer A)

Outer Layer A)

In accordance with the invention the outer layer is radiation-curable. The outer layer used is therefore a radiation-curable composition comprising free-radically or ionically curable groups (curable groups for short). Preference is given to free-radically curable groups.

The radiation-curable layer may be colored or colorless.

The radiation-curable composition is preferably transparent to the radiation used in the curing step 4). After curing has taken place, as well, the outer layer is preferably transparent, i.e., it is a clearcoat layer.

A key constituent of the radiation-curable compositions is the binder, which forms the outer layer by film formation.

The radiation-curable composition preferably comprises at least one binder selected from the group consisting of
i) polymers containing ethylenically unsaturated groups and having an average molar mass Mn of more than 2000 g/mol
ii) mixtures of i) with non-i), ethylenically unsaturated, low molecular mass compounds having a molar mass of less than 2000 g/mol
iii) mixtures of saturated thermoplastic polymers with ethylenically unsaturated compounds.

Examples of compounds i), ii), and iii) are found in WO 00/63015, particularly from page 2 line 27 to page 6 line 15 therein, in WO 2005/080484, particularly from page 2 line 39 to page 17 line 22 therein, and in WO 2005/118689, particularly from page 2 line 40 to page 20 to line 14 therein, each of these publications being hereby incorporated by reference. Preferred binders are those of the kind described in WO 2005/080484, particularly from page 2 line 39 to page 17 line 22 therein.

Preferably the binder has a glass transition temperature (T_{g}) below 60° C., preferably below 40° C., more preferably below 20° C. In general the T_{g} is not below a value of −60° C. (The figures refer to the binder prior to radiation curing.)

The glass transition temperature T_{g} of the binder is determined by the DSC method (Differential Scanning Calorimetry) in accordance with ASTM 3418/82, with a heating rate of 10° C./min.

The amount of the curable, i.e., ethylenically unsaturated groups is in one preferred embodiment more than 2 mol/kg, preferably more than 2 mol/kg to 8 mol/kg, more preferably at least 2.1 mol/kg to 6 mol/kg, very preferably 2.2 to 6, in particular 2.3 to 5, and especially 2.5 to 5 mol/kg of the binder (solids), i.e., without water or other solvents.

The radiation-curable compositions may comprise further constituents. Particular mention may be made of photoinitiators, flow control agents, and stabilizers. In the case of applications in the outdoor sector, i.e., for coatings which are exposed directly to daylight, the compositions comprise, in particular, UV absorbers and free-radical scavengers.

Examples of compounds which can be used as accelerants for the thermal aftercure include tin octoate, zinc octoate, dibutyltin laureate or diaza[2.2.2]bicyclooctane.

Photoinitiators may for example be the photoinitiators known to the skilled worker, examples being those specified in “Advances in Polymer Science”, Volume 14, Springer Berlin 1974, or in K. K. Dietliker, Chemistry and Technology of UV and EB Formulation for Coatings, Inks and Paints, Volume 3; Photoinitiators for Free Radical and Cationic Polymerization, P. K. T. Oldring (Ed.), SITA Technology Ltd, London.

Suitable examples include photoinitiators of the kind described in WO 2005/080484 A1, page 18 line 22 to page 19 line 10, which is hereby incorporated by reference.

With particular preference the photoinitiators are selected from the group consisting of 2,4,6-trimethylbenzoyidiphenylphosphine oxide (Lucirin® TPO from BASF AG), ethyl 2,4,6-trimethylbenzoylphenylphosphinate (Lucirin® TPO L from BASF AG), bis(2,4,6-trimethylbenzoyl)phenylphosphine oxide (Irgacure® 819 from Ciba Spezialitatenchemie), and mixtures comprising bis(2,6-dimethoxybenzoyl)-2,4,4-trimethylpentylphosphine oxide, such as those with 2-hydroxy-2-methyl-1-phenylpropan-1-one (Irgacure(® 1700 from Ciba Spezialitatenchemie) or with 1-hydroxycyclohexyl phenyl ketone (Irgacure® 1800 from Ciba Spezialitätenchemie).

UV absorbers convert UV radiation into heat energy. Known UV absorbers are hydroxybenzophenones, benzotriazoles, cinnamic esters, and oxalanilides.

Free-radical scavengers bind free radicals formed as intermediates. Important free-radical scavengers are sterically hindered amines, which are known as HALS (Hindered Amine Light Stabilizers).

For outdoor applications the amount of UV absorbers and free-radical scavengers in total is preferably 0.1 to 5 parts by weight, more preferably 0.5 to 4 parts by weight, per 100 parts by weight of the radiation-curable compounds.

As well as radiation-curable compounds, the radiation-curable composition may further comprise compounds which contribute to curing by means of other chemical reactions. Suitable examples include polyisocyanates which crosslink with hydroxyl or amine groups.

The radiation-curable composition may be in water- and solvent-free form, in the form of a solution or in the form of a dispersion.

Preference is given to water-free and solvent-free, radiation-curable compositions or to aqueous solutions or aqueous dispersions.

Particular preference is given to water-free and solvent-free, radiation-curable compositions.

It may, however, also be sensible to give the radiation-curable composition a thermoplastically shapeable configuration, in order, for example to make it extrudable.

The above radiation-curable compositions form the outer layer. The layer thickness (after drying and curing) is for example 1 to 1000 μm, preferably 10 to 100 μm.

Substrate Layer D)

The substrate layer serves as a support and is intended to ensure a durably high toughness for the overall assembly.

The substrate layer is composed preferably of a thermoplastic polymer, especially polymethyl methacrylates, polybutyl methacrylates, polyethylene terephthalates, polybutylene terephthalates, polyvinylidene fluorides, polyvinyl chlorides, polyesters, polyolefins, acrylonitrile-ethylene-propylene-diene-stryene copolymers (A-EPDM), polyetherimides, polyetherketones, polyphenylene sulfides, polyphenylene ethers or mixtures thereof.

Mention may additionally be made of polyethylene, polypropylene, polystyrene, polybutadiene, polyesters, polyamides, polyethers, polycarbonate, polyvinyl acetal, polyacrylonitrile, polyacetal, polyvinyl alcohol, polyvinyl acetate, phenolic resins, urea resins, melamine resins, alkyd resins, epoxy resins or polyurethanes, their block or graft copolymers, and blends thereof.

Mention may be made with preference of ABS, AES, AMMA, ASA, EP, EPS, EVA, EVAL, HDPE, LDPE, MABS, MBS, MF, PA, PA6, PA66, PAN, PB, PBT, PBTP, PC, PE, PEC, PEEK, PEI, PEK, PEP, PES, PET, PETP, PF, PI, PIB, PMMA, POM, PP, PPS, PS, PSU, PUR, PVAC, PVAL, PVC, PVDC, PVP, SAN, SB, SMS, UF, UP polymers (abbreviated codes to DIN 7728), and aliphatic polyketones.

Particularly preferred substrates are polyolefins, such as PP (polypropylene), which optionally may be isotactic, syndiotactic or atactic and optionally may be unoriented or oriented by uniaxial or biaxial drawing, SAN (styrene-acrylonitrile copolymers), PC (polycarbonates), PMMA (polymethyl methacrylates), PBT (poly(butylene terephthalate)s), PA (polyamides), ASA (acrylonitrile-styrene-acrylic ester copolymers), and ABS (acrylonitrile-butadiene-styrene copolymers), and also their physical mixtures (blends). Particular preference is given to PP, SAN, ABS, ASA, and blends of ABS or ASA with PA or PBT or PC.

Very particular preference is given to ASA, particularly in accordance with DE 19 651 350, and to the ASA/PC blend, and also SAN. Preference is likewise given to polymethyl methacrylate (PMMA) or impact-modified PMMA.

The layer thickness is preferably 50 μm up to 5 mm. Particular preference, especially if the substrate layer is insert molded, is given to 100 to 1000 μm, in particular 100 to 500 μm.

The polymer of the substrate layer may comprise additives. Fillers or fibers are especially suitable. The substrate layes may also be colored and so may serve simultaneously as a coloring layer.

Further Layers

The film may comprise further layers besides the outer layer A) and the substrate layer D).

Suitable examples include coloring interlayers C) or further layers of thermoplastic material (thermoplastic interlayers) B), which reinforce the film or serve as separating layers, as is known, for example, from WO 2004/009251.

Thermoplastic interlayers may be composed of the polymers recited above under “substrate layer”.

Preference is given in particular to polymethyl methacrylate (PMMA), preferably impact-modified PMMA. Mention may also be made of polyurethane.

Coloring layers may likewise be composed of the aforementioned polymers. They comprise dyes and/or pigments which are distributed in the polymer layer.

The number of layers following the substrate may be up to 20 plies. Preference is given to up to 6, particular preference to up to 4.

The layers may also be applied, for example, over the full area, and imagewise, in the form for example of a printed image, or as a layer-thickness relief—in other words, as differently surface-wetting, light-absorbing, light-refracting, light-guiding, current-guiding or heat-guiding relief structures. These layers may be protected by a UV-curable topcoat material.

One preferred film, for example, has the following layer construction, the alphabetic order corresponding to the spatial arrangement:

A) outer layer

B) thermoplastic interlayer (optional)

C) coloring interlayer (optional)

D) substrate layer

E) adhesive layer (optional).

A further preferred film has, for example, the following layer construction, the alphabetic order corresponding to the spatial arrangement:

A) outer layer

B) single- or multi-ply printing (optional)

C) coloring interlayer (optional)

D) substrate layer

E) adhesive layer (optional).

On the reverse side (rear for short) of the substrate layer (i.e., the side facing the article to be coated) it is possible for there to be an applied adhesive layer, if the film is to be adhered to an article.

Applied to the transparent outer layer there may be a protective layer, e.g., a removable sheet, which prevents unintended curing. The thickness can amount, for example, to 50 to 100 μm. The protective layer may be composed, for example, of polyethylene, polypropylene, polycycloolefins, silicone, polyhydrofluorocarbons or polyterephthalate. The removable sheet can be removed prior to the shaping step. It must be removed if the protective sheet itself is not sufficiently shapeable.

The protective sheet may be smooth or textured. Texturing serves, for example, to emboss a texture onto the topcoat layer.

Alternatively, irradiation may take place through the protective layer, in which case the protective layer must be transparent in the wavelength range of the irradiation.

The total thickness of the composite film is preferably 50 to 1000 μm.

Production of the Composite Film

A composite of layers B) to D) can be produced by means for example of coextrusion of some or all of these layers.

For the purpose of coextrusion, the individual components are fluidized in extruders and, by way of special means, are brought into contact with one another in such a way as to result in the films having the layer sequence described above. The components, for example, can be coextruded through a slot die. This method is illustrated in EP-A2-0 225 500. As well as the methods described therein it is also possible to use what is called adapter coextrusion.

The composite can be produced by customary methods, as for example by coextrusion, as described above, or by lamination of the layers, in a heatable nip, for example. In this way a composite can first be produced from the layers with the exception of the outer layer, and subsequently the outer layer can be applied by typical methods.

In the case of the extrusion (including coextrusion) of the radiation-curable compositions, the preparation of the radiation-curable composition by mixing of the constituents and the production of the outer layer can take place in one operation.

This can be done by first melting thermoplastic constituents, such as the unsaturated polymers i) indicated above or saturated polymers under iii) (see above), in an extruder. The necessary melting temperature depends on the respective polymer. After the melting operation, preferably, the further constituents can be metered in, especially radiation-curable compounds ii) of low molecular mass (see above). The compounds act as plasticizers, thereby lowering the temperature at which the composition is in the form of a melt. The temperature when the radiation-curable compound is added must in particular be beneath what is known as a critical temperature, at which thermal curing of the radiation-curable compound takes place.

The critical temperature can be easily determined by means of a calorimetric measurement, i.e., a measurement of the heat intake with increasing temperature, in accordance with the above-described determination of the glass transition temperature.

The radiation-curable composition is then extruded directly as an outer layer onto the existing composite or, in the case of coextrusion, is extruded with layers of the composite.

Extrusion produces the composite layered film directly.

The radiation-curable composition can be applied to the substrate layer or composite preferably in a simple way, as for example by spraying, injecting, spreading, trowelling, knife coating, brushing, rolling, roller coating, pouring, laminating, etc., and can be dried if appropriate.

In a further embodiment the binder and/or the radiation-curable composition can also be applied in melted form.

The coating composition can be applied singly or multiply by any of a very wide variety of spraying methods, such as air-pressure, airless or electrostatic spraying methods, using one-component or two-component spraying units, or else by injecting, trowelling, knife coating, brushing, rolling, roller coating, pouring, laminating, insert molding or coextruding.

The coating thickness is situated generally in a range from about 3 to 1000 g/m² and preferably 10 to 200 g/m².

The outer layer is radiation-crosslinkable. The composite film is thermoelastically deformable. If desired, a protective layer (protective sheet, removal sheet) can be placed on the outer layer directly after the production of the composite film. The protective sheet, as well as protecting against mechanical and contaminating influences or against premature exposure to light, also makes it possible for topcoat layers which are not blocking-resistant to be given a stackable or windable finish. In addition, it may serve for smoothing or, conversely, for the embossing of a texture onto the surface.

The composite layered film has a high gloss and good mechanical properties. Virtually no cracking is observed.

The extensibility of the composite layered film is preferably at least 100%, based on the unextended state (at 140° C., with a thickness of 50 μm). Extension may take place at different temperatures up to 250° C., preferably between 20° C and 200° C.

2) If Appropriate, Drying of the Different Layers of the Composite Film Thus Obtainable

The drying of the coatings takes place, if desired, in general under standard temperature conditions, i.e., without heating of the coating. Where the coating compositions comprise solvents, drying may be carried out, after application, at elevated temperatures, such as 40-250° C., preferably 40-150° C., and in particular at 40 to 100° C. This is limited by the thermal stability of the film.

The drying and/or thermal treatment may also, in addition to or instead of the thermal treatment, take place by means of NIR radiation, NIR radiation here meaning electromagnetic radiation in the wavelength range from 760 nm to 2.5 μm, preferably from 900 to 1500 nm.

3) Shaping of the Composite Film Obtainable from 1) or 2) By Thermoforming or Attachment to an Article

The film may be stored without partial curing (as described in EP-A2 819 516) until its subsequent use.

Sticking or deterioration in the performance properties prior to subsequent use is observed hardly at all or not at all.

In the shaping step, step 3),
the composite which is obtainable, if a planar film which has been applied beforehand to a suitable planar article, by lamination for example, can be shaped by thermoforming;
the film, after its corresponding shaping, can be applied to a three-dimensionally shaped substrate;
the three-dimensionally shaped substrate can be joined to the unshaped, i.e., planar, film, the film being shaped correspondingly on the substrate (attachment); or
the planar film can be shaped in a suitable way, as for example by injection backmolding, foam backing, backfilling or compression backmolding with different materials, based on plastics, wood, paper, metal, ceramic, etc.; this results in the components.

In this context it is possible to use typical methods and means, of the kind known, for example, from the American U.S. Pat. No. 4,810,540 A, U.S. Pat. No. 4,931,324 A or U.S. Pat. No. 5,114,789 A or from the European patents EP 266 109 B1, EP 285071 B1, particularly page 13 line 41 to page 14 line 31 therein for a thermoforming operation and page 14 line 35 to page 15 line 19 for an insert molding operation, EP 352298 B1 or EP 449982 B1. Preference is given in this context to the method described in EP 285071 B1.

For the thermoforming operation the dry-paint film is heated preferably to a temperature in the region of the glass transition temperature of the dry-paint film. The preferred operating temperature of the shaping operation lies in the range from 20° C. to 250° C., more preferably 80 to 190° C. The film thus heated is then subjected to crease-free and permanent thermoforming via a thermoforming mold tool by means of vacuum or by means of pressure applied to the reverse. The thermoformed dry-paint film can then be cut out or punched out in accordance with a desired circumferential contour.

In accordance with the invention, after the thermoforming or after the insert molding of step 5) this dry-paint film is radiation-cured.

For attachment to an article, said article is introduced into the mold on the mold side facing the underside of the dry-paint film. The article in this case itself forms a component of the mold, in particular in the manner of a punch. The term “article” refers to any desired two- and in particular three-dimensional product, especially modules, parts of assemblies or components for composite components, which are present in their proper geometric form. The materials of the articles include wood materials, ceramic materials, metals, plastics, foams, and composite materials, particularly the materials that are customary in motor-vehicle construction in the bodywork region, and also for construction materials or, generally, plastic or glass housings or plastic or glass windows.

In the next of the key steps of the method, the dry-paint film is heated in order to make it plastically deformable. If appropriate, this heating also activates corresponding adhesives. The dry-paint films suitable for the method are composed at least in part of thermoplastic polymers or plastics. In accordance with the method, the dry-paint film is heated at least above the glass transition temperature of its polymer constituents, so that the dry-paint film becomes readily shapeable. The preferred operating temperature of the shaping operation lies in the range from 20° C. to 250° C., more preferably 80 to 190° C., and can be set prior to the actual shaping or not until during the shaping operation. The article which forms part of the mold may be preheated or unpreheated, in accordance with the best bond strength of the film-substrate composite. In the course of the subsequent shaping operation, the dry-paint film is attached at least to the visible faces of the article. This operating step is also referred to as thermoforming.

In a first embodiment the article is utilized as a mold, as a punch for example, and is moved into or through the film plane of the tensioned dry-paint film. In this case the dry-paint film is attached uniformly to the article.

In a second embodiment, the article remains in its position and the dry-paint film is pressed by the application of a pressing pressure at least onto the visible face of the article. The pressing pressure can be effected in a known way by means of an air overpressure, or by a mold shaped complementarily to the article.

It is likewise possible to perform these two variant methods simultaneously or else in succession with any of a very wide variety of time overlaps.

In accordance with the invention, the film attached to the article is radiation-cured within the same apparatus.

With particular preference the dry-paint film is drawn not only over the visible part of the article but also over the boundary margins and edges. Envisioned in particular in this context is the lamination of the cut edges of metallic articles. This is of particular advantage if the strip-metal sheets that are customary in bodywork construction, and are pretreated with corrosion protection or other coatings, are used to produce the articles. The strip-metal sheets typically lose their coating at the cut edges and margins, leading then to corrosion problems in service. Final coatings with color or effect coating materials in such instances frequently no longer afford suitable corrosion protection. In contrast, the dry-paint films applied in the manner described exhibit outstanding protection of the edges and margins. The dry-paint films are especially advantageous even when exposed regions of the components are subject to a particular mechanical load as a result of striking, impact or abrasion. Consideration may be given, for example, to stone chip protection films. In contrast to the known processing of the film-coated metal sheets, in the method described, film and strip metal sheet are cut to size separately and are shaped at different stages. The firm assembly produced between the surface of the article and the dry-paint film is brought about by the adhesive effect of the temporarily softened bottom polymer layer and/or, preferably, by an additional adhesive layer or adhesion promoter layer E). Adhesives or adhesion promoters may in this case be applied both to the dry-paint film and to the article.

Coating can take place by adhering the film to the substrates. For this purpose the film, on the reverse of the substrate layer, is provided preferably with the adhesive layer E). Particularly suitable articles are those of wood, plastic, foam material, metal, glass, and ceramic.

4) Radiation Curing in 3) of the Shaped Composite Film

In accordance with the invention, within the same apparatus in which the shaping is carried out, the shaped film is also radiation-cured.

This radiation curing of the outer layer takes place preferably after the thermoforming or attachment operation as described under 3) and in the case of thermoforming can take place before or after the insert molding of the film, as described under 5).

The surfaces obtained in this way have advantages in terms of surface quality. For example, there are fewer surface defects due to incidence of dust, and, generally speaking, the mechanical and chemical resistance properties of the surfaces are better.

Radiation curing is accomplished using high-energy light, examples being UV light or electron beams. Radiation curing can take place at relatively high temperatures. Preference is given in this case to a temperature above the glass transition temperature T_{g} of the radiation-curable binder.

Irradiation takes place preferably on the outer-layer side of the film. Irradiation can be carried out through the substrate film D) generally only when the substrate film D) and the interlayers B) and/or C), present if appropriate, are transparent to the radiation used in radiation curing.

Where the radiation curing takes place through the (thermoforming) mold, that mold is of course of a design such that it is transparent to the radiation in question, being made of glass or plastic, for example.

If the film has been thermoformed in step 3), the radiation curing of the outer layer A) takes place preferably not until after the detachment from the thermoforming mold, from the outer-layer side, more preferably after insert molding has additionally taken place, as described under 5), and after the insert-molded film has been detached from the thermoforming mold.

Where the film has been attached to an article in 3), the radiation curing of the outer layer A) takes place from the outer-layer side.

Radiation curing here is the free-radical polymerization of pdlymerizable compounds as a consequence of electromagnetic and/or particulate radiation, preferably light in the wavelength range above λ=200 nm and/or electron beams in the range from 150 to 300 keV, and with particular preference light of wavelengths from 250 to 700 nm and with a radiation dose of at least 80, preferably 80 to 3000 mJ/cm².

Besides radiation curing there may also be further curing mechanisms involved, examples being thermal, moisture, chemical and/or oxidative curing (dual cure).

In the case of an additional thermal cure, curing can also be carried out by subjecting the article to thermal treatment, following application of the film, in order to bring about a quick preliminary cure, at temperatures up to 160° C., preferably between 60 and 160° C., and subsequently carrying out curing to completion using electron beams or UV exposure, under oxygen or, preferably, under inert gas.

Examples of suitable radiation sources for the radiation cure include low-pressure, medium-pressure, and high-pressure mercury lamps and also fluorescent tubes, pulsed emitters, metal halide lamps, halogen lamps, LED lamps, flash lamps, and electronic flash installations, which enable radiation curing without photoinitiator, or excimer emitters. Radiation curing is accomplished by exposure to high-energy radiation, i.e., UV radiation or daylight, preferably light in the wavelength range above λ=200 nm, more preferably the range of λ=250 to 700 nm and with very particular preference λ=250 to 500 nm, or by bombardment with high-energy electrons (electron beams; 150 to 300 keV). Examples of radiation sources used include high-pressure mercury vapor lamps, lasers, pulsed lamps (flashlight), halogen lamps or excimer emitters. The radiation dose typically sufficient for crosslinking in the case of UV curing is situated in the range from 80 to 3000 mJ/cm².

In one preferred embodiment the radiation source is selected from the group consisting of high-pressure mercury lamps, low-pressure mercury lamps, halogen lamps, and flash lamps, more preferably flash lamps.

Preferred high-pressure mercury lamps have power densities of the luminous means of up to 400 W/cm lamp length and can also be used at relatively high temperatures, up to 300° C. for example, so making them particularly suitable for the application of the invention. Owing to the fact that these lamps, in the version with electrodes for ignition, require startup periods of several minutes, frequently about 3 minutes, in order to develop their full power, and since multiple switching cycles reduce the lifetime of these lamps, high-pressure mercury lamps are used preferably, for the purposes of this invention, as lamps which can be closed off with shields and are therefore switchable and yet provide long burning times. Shortened start times are possessed by microwave-started, electrode-free lamps, which can be used even without closing shields.

Preferred low-pressure mercury lamps can be switched within the region, approximately, of seconds. Their power density, based on the lamp length, is substantially lower than that of the high-pressure mercury lamps; correspondingly high lamp lengths and individual numbers, and also, if appropriate, irradiation times, must be taken into account. At temperatures above 100° C., these lamps are unsuitable, owing to a sharp drop in performance.

In one particularly preferred embodiment of the present invention, step 4) is carried out using pulsed lamps, preferably xenon flash lamps. Pulsed lamps for industrial or photographic applications have very high power densities per flash (up to 100 kW) for short times. Typical power ranges are 30 W to 20 kW. The spectra emitted comprise a broad spectral range in the visible and ultraviolet spectrum. Suitable flash lamps are described for example in WO-A-94/11123 and in EP-A-525340. Particular preference is given to flash lamps with a light emission in the wavelength range between 200 and 900 nm and a maximum around 500 nm. At the surface of the film, at least 5 megalux per flash discharge ought to be achieved, preferably 10-70 megalux. For this purpose, preference is also given to the coupling of two or more flash lamps. Accordingly, further-preferred flash lamps also include relatively weak-powered lamps in the range of the kind used in the photographic sector.

The dry-paint films, can be cured by means of two or more flash discharges, preferably by 1 to 20, very preferably by 1 to 5, flashes.

A particular advantage through the use of the pulsed lamps are the exposure times, which are short in comparison to other lighting means, with the consequence that the cycle times per coated part for thermoforming and coating, with the heating, cooling, vacuum and aeration procedures, are not prolonged by the subsequent light curing, or are only insubstantially prolonged, by about 0-30 seconds. The energy consumption is limited to the cure time. With medium-pressure or high-pressure mercury lamps, it is necessary for the lamps, in order to avoid switch-on and switch-off phases lasting minutes, which in each case also adversely affect the lifetime of the lamps, particularly in the case of lighting means comprising electrodes, and/or adversely affect the starting electrics of the lamps, particularly in the case of microwave-started lamps.

The distance of the flash lamps from the film surface is between 1 and 100 cm, preferably 5 to 50 cm.

Frequently, filters in the lamp glass or reflector glass filter out the UV B and/or UV C fractions and also other UV fractions. In this case it is particularly preferred to use the preferred photoinitiators indicated above.

It is of course also possible to use two or more radiation sources for curing, in order to achieve the radiation dose necessary for optimum curing.

These sources may also emit differently and each in different wavelength ranges.

In one preferred embodiment, irradiation may also be carried out under exclusion of oxygen or oxygen-depleted atmosphere, as for example with an oxygen partial pressure of less than 18 kPa, preferably 0.5-18 kPa, more preferably 1-15 kPa, very preferably 1 to 10 kPa, and in particular 1-5 kPa, or under inert gas atmosphere. Suitable inert gases include, preferably, nitrogen, noble gases, carbon dioxide, water vapor or combustion gases. The reduction of the oxygen partial pressure can also be accomplished by lowering the ambient pressure. Furthermore, irradiation may take place with the coating material covered with transparent media. Examples of transparent media include polymeric films, glass or liquids, water for example. Particular preference is given to irradiation in the manner as described in DE-A1 199 57 900.

Further barrier layers may be films composed of hydrophobic or hydrophilic waxes or liquids which have a barrier effect to atmospheric oxygen.

Thus in one preferred embodiment of the present invention a barrier layer for the outer layer to be cured is represented by a removable protective sheet, which protects the outer layer against oxygen exposure.

A further possibility is to use this film to generate or reinforce particular surface qualities on the article, examples being
“golf ball” surface for reducing the flow resistance, particularly the air resistance,
“shark skin” with resistance-reducing grooved surfaces (riblets) for reducing the flow resistance, both of gases and of fluids (drag reduction),
lotus effect,
matting effect,
but also for texturing the surface (smooth, textured, matt, motif structures, e.g., image structures, wood surface profile, grained leather appearance, etc.).

Where crosslinkers as well are comprised which effect additional thermal crosslinking, isocyanates for example, it is possible, for example, at the same time or else after the radiation cure, to carry out the thermal crosslinking through an increase in temperature to up to 150° C., preferably up to 130° C., if appropriate with exposure to atmospheric moisture. Thermal crosslinking may also take place without additional heating, over an aftercure time of several hours to days.

5) If Appropriate, Insert Molding of the Shaped Composition Film Cured in 4)

A film thermoformed in step 3) can be preferably used for insert molding or a planar film can be shaped in a suitable way, as for example by injection backmolding, foam backing, backfilling or compression backmolding with different materials, based on plastics, wood, paper, metal, ceramic, etc., thereby resulting in the components.

In this context it is possible to use typical methods and means, of the kind known, for example, from the American U.S. Pat. No. 4,810,540 A, U.S. Pat. No. 4,931,324 A or U.S. Pat. No. 5,114,789 A or from the European patents EP 266 109 B1, EP 285071 B1, particularly page 13 line 41 to page 14 line 31 therein for a thermoforming operation and page 14 line 35 to page 15 line 19 for an insert molding operation, EP 352298 B1 or EP 449982 B1.

For this purpose the thermoformed films are preferably treated as follows: the film is thermoformed, preferably in a thermoforming mold, and the reverse of the substrate layer is injection-backmolded with polymeric compound. The polymeric compound comprises, for example, polymers listed above in connection with the description of the substrate layer or, for example, polyurethane, especially polyurethane foam. The polymers may comprise additives, particularly for example fibers, such as glass fibers, plant fibers, or fillers.

The punched and thermoformed dry-paint film is for this purpose inserted into an injection mold and injection-backmolded, foam backed or backfilled with a plastic. For the faithful shaping of the article to be produced by insert molding and complete with decoration, it is possible for the elastic dry-paint film, in the course of insert molding, to be pressed at the same time against the boundaries of the injection mold that have been machined negatively with respect to the desired shape of the article. After the curing of the plastic used for insert molding, the fully decorated article is removed from the injection mold.

This demolded article is then preferably cured by radiation onto the outer layer A).

Fields of Use and Advantages

The films can be used to coat two-dimensional and three-dimensional shaped articles. Any desired shaped articles are accessible in this context. Particular preference is given to using the films to coat shaped articles for which very good surface properties, high weathering stability, and good UV stability are important factors. The surfaces obtained, moreover, are very scratch-resistant, chemicals-resistant, weathering-resistant, and thermally adhering, so that destruction of the surfaces by weathering, scratching or detachment of the surfaces is reliably prevented. Accordingly, shaped articles for use in the outdoor sector, outside buildings, are a preferred field of application. In particular the films are used to coat motor-vehicle components, examples including wings, door trims, bumpers, spoilers, skirts, and exterior mirrors.

The films are outstandingly suitable for producing decorative and/or protective coatings on means of transport, including aircraft, ships, rail vehicles, muscle-powered vehicles, motor vehicles, and components thereof, buildings, in the interior and exterior sectors, and parts thereof, doors, windows, and furniture, and also in the context of the industrial coating of hollow glassware, coils, containers, packaging, small industrial parts, such as nuts, bolts, hubcaps, optical components, electrical components, such as windings, including coils and stators and rotors for electric motors, mechanical components, and components for white goods, including household appliances, boilers, and radiators. In particular the films serve for coating three-dimensional components, especially surface-mounted components for producing automobile bodies. Consequently, coating materials suitable for automobile bodies are preferably used for producing the films, but must have the flexibility required for the purposes of the invention.

With particular preference the article represents a component for a vehicle body. Such components include, in particular, small parts which are inserted into larger areas of bodywork, examples being fuel caps, trunk linings, transverse or longitudinal columns or beams, door handles, and the like. For these applications in particular, the exact and consistent quality of color and effect on the objects is necessary, and must not deviate from that of the bodywork surrounding them. It is here that the dry-paint films and the application method of the invention show particular advantages over conventional finishing.

Advantageously, furthermore, interior automotive components, such as dashboard linings or interior car door linings, for example, can be produced by the foam backing of films and curing as described above. For this purpose the film is preferably covered with a textured protective sheet, in order to obtain a leather appearance, for example, and is cured through said sheet.

As well as vehicles in the automobile segment, it is likewise possible to conceive, generally, of utility vehicles, aircraft, ships, boats, and rail vehicles.

Particular preference is also given to the coating of doors, windows, wall elements, floor-covering elements, facing elements, and roof elements, and also furniture surfaces. Preference likewise attaches to the production of casing shells for appliances, particularly in the household segment, such as refrigerators, washing machines and dishwashers, coffee machines, microwaves, computers, telephones, PDAs, toys, consumer electronics devices, musical instruments, sports equipment, or devices used commercially.

ppm and percentage figures used in this specification relate, unless indicated otherwise, to weight percentages and to ppm by weight.

The examples which follow are intended to illustrate the invention but not to restrict it to these examples.

### EXAMPLES

### Example 1

A thermoformable PERMASkinfolie® film (BASF Aktiengesellschaft, Ludwigshafen) is coated with a UV-curable clearcoat material consisting of Laromer® UA 9047 V (radiation-curable one-component urethane acrylate based on hexamethylene diisocyanate, BASF Aktiengesellschaft, Ludwigshafen) and, as a photoinitiator mixture, 3% of 1-hydroxycyclohexyl phenyl ketone and 0.5% of 2,4,6-trimethylbenzoyldiphenylphosphine oxide (Lucirin® TPO, BASF Aktiengesellschaft, Ludwigshafen), based on nonvolatile fractions, coating taking place via knife application for a dry film thickness of 50 g/m². Drying takes place at 50° C. over 15 minutes.

The film is clamped into a frame 59 cm wide and 69 cm long, and is introduced into a thermoforming apparatus composed of a bottom part, for accommodating a substrate plate, the stated insertable frame, and a lid approximately 45 cm high; all of the components can be sealed vacuum-tight with respect to one another. Gassing and evacuation can be accomplished, in each case independently, via base and lid. In the lid there are IR lamps for heating, and an IR temperature detector for temperature measurement and regulation. In the assembly of lid with frame, the film is heated to approximately 180° C. and is pulled in the lid by subatmospheric pressure, so making room for the substrate plate. Thereafter the entire apparatus is closed with the bottom part, comprising the substrate plate. By vacuum drawing in the region between film and substrate, the film is drawn onto the substrate without bubbles. The substrate used is a profiled MDF plate having a maximum height of 1.9 cm and an area of 50 cm*60 cm. Within the aluminum-clad lid, the apparatus, as well as the IR lamps, also comprises 30 flash lamps (lighting-element length 46 mm, lamp spacings 10 cm (commercial photographic flash lamps used, for example, for MECABLITZ 45 CL 1 (Metz GmbH, Zirndorf)) for UV irradiation. After the film has been drawn onto the wooden substrate, nitrogen is passed over the applied film. At an interior temperature of 100° C., which is achieved during the cooling and gassing of the film drawn onto the wooden plate, exposure is then carried out with 3 flashes at 5-second intervals. The entire cycle time is 70 seconds, and is not prolonged as a result of the exposure.

### Example 2

Drawing on and application take place as in Example 1. Instead of the photographic flash lamps, industrial UV flash lamps (lighting-element length approximately 190 mm, output max. 4000 J) are used in the Flood Head flash head in conjunction with the 3000 Ws UV generator from Visit GmbH & CO KG, Wurzburg. 5 flash lamps are used to cure a surface area of 2 m², with a lamp-to-substrate distance of approximately 30 cm.

Both examples produce scratch-resistant, robust surfaces.

### Comparative Examples 3 and 4

Examples 1 and 2 are repeated, in each case the exposure taking place outside the thermoforming apparatus. A container clad with aluminum surfaces and having an area of 90 cm*110 cm and a depth of 100 cm is charged with 3 kg of dry ice. This produces a residual oxygen content of approximately 1 percent by volume. The substrate, which is still at a temperature of approximately 100° C., is suspended such that the lid, comprising the flash lamps, from experiments 1 and 2, has a comparable distance of 30 cm between lamps and film surface.

The scratch resistance of the painted surfaces was by measuring the loss of gloss (measurement angle 20°) after scratching with 10 and 50 double rubs (DR) with a Scotch Brite™ pad (3M) which was loaded by a hammer weighing 500 g. The surfaces from Examples 1 and 2 exhibit fewer defects in this test, as a result of incidence of dust, and are more scratch-resistant:

Relative loss of gloss after scratching:

Rel. loss of gloss [%]

| Examples | 10 DR | 50 DR |
|---|---|---|
| 1 | 83.5 | 68.6 |
| 2 | 85.8 | 70.1 |
| 3 | 75.3 | 62.5 |
| 4 | 77.6 | 64.5 |

1. A method of producing a film-coated article, comprising at least:
1) coating a film-form substrate D) with at least one radiation-curable outer layer A) to produce a composite film,
3) shaping the composite film obtained from said coating by thermoforming or attachment to an article, and
4) radiation curing of the shaped composite film,
wherein 3) and 4) are performed in the same apparatus.

2. The method according to claim 1, further comprising 2) drying said composite film, which occurs at least partly in the same apparatus.

3. The method according to claim 1, further comprising 5) insert molding the cured composite film, which occurs at least partly in the same apparatus.

4. The method according to claim 1, wherein the radiation-curable outer layer A) comprises at least one binder selected from the group consisting of
i) polymers containing ethylenically unsaturated groups and having an average molar mass Mₙ of more than 2000 g/mol
ii) mixtures of i) with ethylenically unsaturated, low molecular mass compounds having a molar mass of less than 2000 g/mol, and
iii) mixtures of saturated thermoplastic polymers with ethylenically unsaturated compounds.

5. The method according to claim 1, wherein the radiation-curable outer layer A) comprises at least one photoinitiator selected from the group consisting of
2,4,6-trimethylbenzoyldiphenylphosphine oxide,
ethyl 2,4,6-trimethylbenzoylphenylphosphinate,
bis(2,4,6-trimethylbenzoyl)phenylphosphine oxide,
a mixture comprising bis(2,6-dimethoxybenzoyl)-2,4,4-trimethylpentylphosphine oxide and 2-hydroxy-2-methyl-1-phenylpropan-1-one, and a mixture comprising bis(2,6-dimethoxybenzoyl)-2,4,4-trimethylpentylphosphine oxide and 1-hydroxycyclohexyl phenyl ketone.

6. A dry-paint film obtained by the method according to claim 1, comprising:
A) an outer layer, and
D) a substrate layer.

7. (canceled)

8. The dry-paint film according to claim 6, further comprising a protective sheet applied to the outer layer A).

9. The method according to claim 1, wherein a radiation source for the radiation curing is selected from the group consisting of a high-pressure mercury lamp, a low-pressure mercury lamp, and a flash lamp.

10. The method according to claim 1, wherein a radiation source for the radiation curing comprises a flash lamp.

11. The method according to claim 10, wherein said flash lamp emits light in the wavelength range between 200 and 900 nm.

12. The method according to claim 10, further comprising selecting the luminous intensity of the flash lamp so that, at the surface of the film, at least 5 megalux per flash discharge are to be achieved.

13. The method according to claim 1, wherein the radiation curing is performed under oxygen exclusion or oxygen-depleted atmosphere.

14. The method according to claim 1, wherein the radiation curing comprises protecting the film from oxygen exposure by a removable protective sheet.

15. A coating operable for at least one of decoration and protection for a transport, an aircraft, a ship, a rail vehicle, a muscle-powered vehicle, a motor vehicle, or components thereof, a building, an interior sector of a building, an exterior sector of a building, or parts thereof, a door, a window, and furniture, hollow glassware, a coil, a container, a packaging, a small industrial part, a nut, a bolt, a hubcap, an optical component, an electrical component, a winding, a stator for electric motors, a rotor for electric motors, a mechanical component, a component for white goods, a household appliance, a boiler, and a radiator made by the method according to claim 1.

16. The method according to claim 1 for producing three-dimensional components.

17. The method according to claim 6, wherein the constructed dry-paint film further comprises a thermoplastic interlayer.

18. The method according to claim 6, wherein the constructed dry-paint film further comprises a coloring interlayer.

19. The method according to claim 6, wherein the constructed dry-paint film further comprises an adhesive interlayer.

20. The method according to claim 6, wherein the constructed dry-paint film further comprises single- or multi-ply printing.

21. The method according to claim 1, wherein the film-form substrate comprises at least one interlayer.
